(19) United States
(12) Patent Application Publication
(10) Pub. No.: US 2012/0301191 A1
(43) Pub. Date: Nov. 29, 2012

(54) IMAGE FORMING APPARATUS

(75) Inventor: Michiaki Ito, Tokyo (JP)

(73) Assignee: OKI DATA CORPORATION, Tokyo (JP)

(21) Appl. No.: 13/481,784

(22) Filed: May 26, 2012

(30) Foreign Application Priority Data
May 27, 2011 (JP) 2011-118990

(51) Int. Cl. G03G 15/16

(52) U.S. Cl. 399/308

(57) ABSTRACT

An image forming apparatus includes a developer image bearing body that bears a developer image formed of a developer. The developer image bearing body has roughness-imparting particles on a surface thereof. A mean particle diameter d of the roughness-imparting particles and a mean particle diameter D of the developer satisfy a relationship: (½)×D<d<D.

### BACKGROUND OF THE INVENTION

The present invention relates to an image forming apparatus.

An electrophotographic image forming apparatus includes an image forming unit, a transfer unit, and a fixing unit.

The image forming unit includes an image bearing body (for example, a photosensitive drum) for forming a latent image and a developer image thereon. The image forming unit further includes a charging member and a developing member that are disposed around the image bearing body. An exposure unit is disposed between the charging member and the developing member. The charging member uniformly charges a surface of the image bearing body. The exposure unit emits light to expose the surface of the image bearing body to form a latent image. The developing member develops the latent image to form a developer image.

The transfer unit transfers the developer image from the image bearing body to a developer image bearing body (such as an intermediate transfer belt) or a recording medium. The fixing unit fixes the developer image to the recording medium by applying heat and pressure thereto.

Conventionally, there is proposed an image forming apparatus having a developer image bearing body configured so as to prevent deterioration of cleaning performance (see, for example, Japanese Laid-open Patent Publication No. 2007-225969).

However, in the conventional image forming apparatus, there are factors related to the developer image bearing body that cause deterioration of image quality. Therefore, the conventional image forming apparatus may form an image whose quality does not satisfy a predetermined quality level.

### SUMMARY OF THE INVENTION

In an aspect of the present invention, it is intended to provide an image forming apparatus capable of forming an image having high quality.

According to an aspect of the present invention, there is provided an image forming apparatus including a developer image bearing body that bears a developer image formed of a developer. The developer image bearing body has roughness-imparting particles on a surface thereof. A mean particle diameter d of the roughness-imparting particles and a mean particle diameter D of the developer satisfy a relationship: (½)×D<d<D.

With such a configuration, factors causing deterioration of image quality can be reduced. Therefore, an image forming apparatus capable of forming an image having high quality can be obtained.

Further scope of applicability of the present invention will become apparent from the detailed description given hereinafter. However, it, should be understood that the detailed description and specific embodiments, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

In the attached drawings:

FIG. 1 is a schematic sectional view showing a configuration of an image forming apparatus according to Embodiment 1 of the present invention;

FIGS. 2A and 2B are schematic sectional views showing an example of an endless belt according to Embodiment 1;

FIGS. 3A and 3B are schematic sectional views showing another example of the endless belt according to Embodiment 1;

FIG. 4 is a schematic enlarged view showing configuration example of the endless belt according to Embodiment 1;

FIGS. 5A and 5B show experimental results on the endless belt according to Embodiment 1;

FIGS. 6A and 6B show experimental results on the endless belt according to Embodiment 1;

FIG. 7 shows evaluation criterion for evaluating image quality;

FIGS. 8A, 8B and 8C are schematic sectional views for illustrating how developers adhere to the endless belt according to Embodiment 1;

FIGS. 9A, 9B and 9C are schematic sectional views for illustrating how developers adhere to the endless belt according to Embodiment 1;

FIG. 10 is a schematic sectional view showing an endless belt according to Embodiment 2 of the present invention, and

FIG. 11 shows experimental results on the endless belt according to Embodiment 2.

### DETAILED DESCRIPTION OF THE PREFERRED EMBODIMENT

Hereinafter, embodiments of the present invention will be described with reference to drawings. The drawings are provided for illustrative purpose and are not intended to limit the scope of the present invention. In respective drawings, common or similar components or are denoted by the same reference numerals.

### EMBODIMENT 1

An image forming apparatus 1 according to Embodiment 1 of the present invention is intended to enhance image quality by reducing “density unevenness in a solid image”, “graininess of a halftone image” and “hollow defects in a thin line” and by enhancing “cleaning performance”.

The “density unevenness in a solid image” (hereinafter, referred to as solid image density unevenness) indicates a phenomenon in which white blanks appear in a solid image. The “graininess of a halftone image” (hereinafter, referred to as halftone image graininess) indicates a phenomenon in which dots with high graininess appear in a halftone image. The “hollow defects in a thin line” (hereinafter, referred to as thin line defects) indicate a phenomenon in which defects (i.e., areas from which developers come off) appear in a thin line image having a width of, for example, 1-2 mm.

For this purpose, the image forming apparatus 1 of Embodiment 1 includes an endless belt 21 as a developer image bearing body having roughness-imparting particles 104 on a surface thereof. Further, a mean particle diameter d (μm) of the roughness-imparting particles 104 and a mean particle diameter D (μm) of a toner as a developer are defined as described later.

### <Configuration of Image Forming Apparatus>

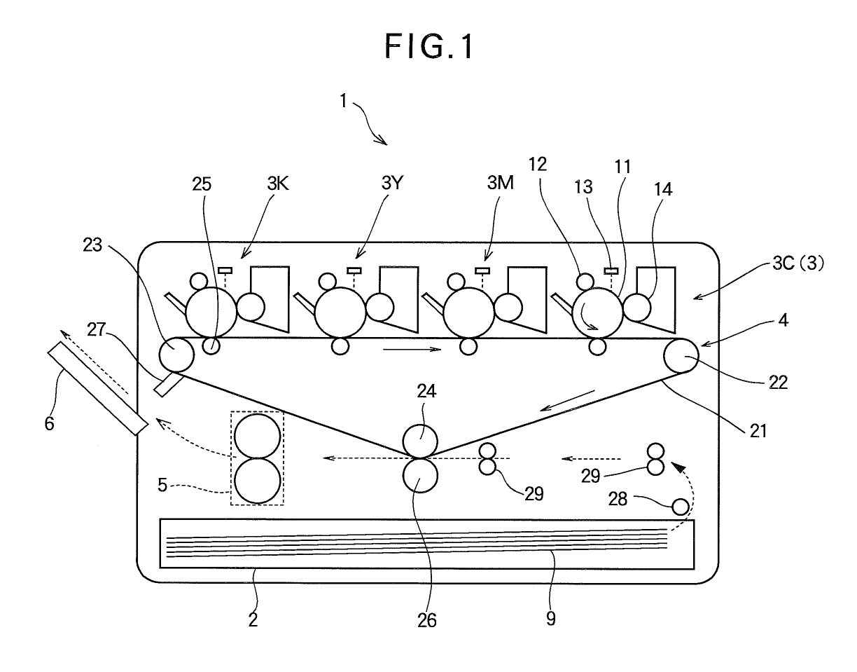

A configuration of the image forming apparatus 1 according to Embodiment 1 of the present invention will be described with reference to FIG. 1. FIG. 1 is a schematic sectional view showing a configuration of the image forming apparatus 1 according to Embodiment 1.

As an example, the image forming apparatus 1 is configured as an electrophotographic color printer of a tandem type and of an intermediate transfer type. The intermediate transfer type is configured to primarily transfer a developer image to an endless belt (as a developer image bearing body), and then secondarily transfer the developer image to a recording medium. Hereinafter, the image forming apparatus 1 will be referred to as a printer 1. Further, an image forming operation will be referred to as a printing operation.

As shown in FIG. 1, the printer 1 includes image forming units 3K, 3Y, 3M and 3C each of which forms a developer image on an image bearing body 11, a transfer unit 4 that transfers the developer images from the image bearing bodies 11 to a sheet 9 (i.e., a recording medium), and a fixing unit 5 that fixes the developer image to the sheet 9. The printer 1 further includes a feeding cassette 2 as a feeding portion that stores the sheets 9 as recording media, and a stacker 6 for placing the sheet 9 on which printing has been done.

The image forming units 3K, 3Y, 3M and 3C are configured to form images of black (K), yellow (Y), magenta (M) and cyan (C). The image forming unit 3K, 3Y, 3M and 3C are disposed on an upper side of an endless belt as a developer image bearing body so that photosensitive drums 11 (described below) contact the endless belt 21. The image forming units 3K, 3Y, 3M and 3C are detachably mounted to a main body of the printer 1.

The image forming units 3K, 3Y, 3M and 3C have the same configuration except colors of the developers (toners). The image forming units 3K, 3Y, 3M and 3C are collectively referred to as the image forming unit 3. The image forming unit 3 may also be referred to as a process unit or a developing unit.

Each image forming unit 3 includes the image bearing body 11 on which a latent image and a developer image are to be formed. The image bearing body 11 is configured as a photosensitive drum composed of a metal shaft and a photosensitive layer formed on the metal shaft. Hereinafter, the image bearing body 11 will be referred to as a photosensitive drum 11.

The image forming unit 3 further includes a charging roller 12 as a charging member and a developing roller 14 as a, developer bearing body that are disposed around the photosensitive drum 11. An exposure unit 13 is disposed between the charging roller 12 and the developing roller 14 so as to face the photosensitive drum 11.

The charging roller 12 is configured to uniformly charge a surface of the photosensitive drum 11. The exposure unit 13 is configured to emit light based on a print command (sent from a host device) so as to selectively expose the surface of the photosensitive drum to form a latent image. The exposure unit 13 is configured as an LED head (Light Emitting Diode) head, and is detachably mounted to the main body of the printer 1.

The developing roller 14 is configured to supply a developer (hereinafter, referred to as a toner) 200 to the surface of the photosensitive drum 11 where the latent image is formed. The latent image is developed with the developer 200, and a toner image is formed on the surface of the photosensitive drum 11. The toner image on the surface of the photosensitive drum 11 is transferred to the endless belt 21 (i.e., a developer image bearing body or an intermediate transfer body).

The transfer unit 4 includes the endless belt 21, driving roller 22, driven rollers 23 and 24, primary transfer rollers 25, a secondary transfer roller 26 and a cleaning blade 27 as a cleaning member.

The endless belt 21 (hereinafter, referred to as the belt 21) is configured to bear the toner image as the developer image. The belt 21 contacts the image forming units 3 (3K, 3Y, 3M and 3C). The toner image is primarily transferred from the photosensitive drums 11 of the image forming units 3 to the belt 21, and then secondarily transferred from the belt 21 to the sheet 9 when the sheet 9 moves along with the belt 21.

The driving roller 22 and the driven rollers 23 and 24 constitute a stretching unit around which the belt 21 is stretched. The driving roller 22 and the driven rollers 23 and 24 apply a tension of 6 kg±10% to the belt 21. The belt 21 is horizontally stretched by the driving roller 22 and the driven roller 23, and a lower part of the belt 21 is supported by the driven roller 24 in a downward protruding manner. The belt 21 is moved by a rotation of the driving roller 22. Guide members are provided on both sides of the belt 21. The guide members guide both side ends (i.e., widthwise ends) of the belt 21 to prevent skew of the belt 21.

Each primary transfer roller 25 (as a primary transfer member) is configured to transfer the toner image from the photosensitive drum 11 to the belt 21. The primary transfer roller 25 is disposed on an inner circumferential side of the belt 21 so as to face the photosensitive drum 11. The primary transfer roller 25 is applied with a voltage whose polarity is opposite to a polarity of the toner. With such a voltage, the primary transfer roller 25 attracts the toner from the photosensitive drum 11, and primarily transfers the toner image from the photosensitive drum 11 to the belt 21.

The secondary transfer roller 26 (as a secondary transfer member) is configured to transfer the toner image from the belt 21 to the sheet 9 as a recording medium. The secondary transfer roller 26 is disposed on an outer circumferential side of the belt 21 so as to face the driven roller 24 via the belt 21. In other words, the secondary transfer roller 26 faces the belt 21 at a substantial apex of the belt 21 protruding downward. The secondary transfer roller 26 is applied with a voltage whose polarity is opposite to a polarity of the toner, and attracts the toner image from the belt 21. The printer 1 is configured to convey the sheet 9 through a nip portion between the belt 21 and the secondary transfer roller 26, and the secondary transfer roller 26 secondarily transfers the toner image from the belt 21 to the sheet 9.

The cleaning blade 27 contacts the surface of the belt 21, and removes a residual toner that remains on the surface of the belt 21 after the toner image is transferred to the sheet 9.

The toner image secondarily transferred to the sheet 9 is fixed to the sheet 9 at the fixing unit 5. The fixing unit 5 is configured to fix the toner image (having been transferred to the sheet 9) to the sheet 9. The fixing unit 5 is detachably mounted to the main body of the printer 1.

### <Operation of Image Forming Apparatus>

An operation of the printer 1 will be herein described. When the printer 1 receives a print command from the host device, the printer 1 analyzes the print command and obtains an image data to be printed. Then, the printer 1 starts printing operation.

In each image forming unit 3, the charging roller 12 uniformly charges the surface of the photosensitive drum 11. Then, the LED head 13 emits light to selectively expose the surface of the photosensitive drum 11 according to the image data, so as to form a latent image on the surface of the photosensitive drum 11. The developing roller 14 supplies the toner 200 to the photosensitive drum 11 and develops the latent image to form a toner image (i.e., a developer image). Each primary transfer roller 25 attracts the toner image from the photosensitive drum 11, and transfers the toner image from the photosensitive drum 11 to the belt 21.

When the image data to be printed is a color image data, the image forming units 3 (3K, 3Y, 3M and 3C) form toner images of respective colors on the photosensitive drums 11. The toner images of respective colors are transferred from the photosensitive drums 11 to the belt in an overlapping manner. In other words, a color image is formed on the surface of the belt 21.

A feeding unit 28 feeds the sheet 9 from the feeding cassette 2 to a sheet conveying path, and a conveying unit 29 conveys the sheet 9 a nip portion between the secondary transfer roller 26 and the driven roller 24. The secondary transfer roller 26 transfers the toner image to the sheet 9 when the sheet 9 passes the nip portion between the secondary transfer roller 26 and the driven roller 24.

The sheet 9 to which the toner image is transferred is conveyed to the fixing unit 5. The fixing unit 5 applies heat and pressure to the sheet 9, so that the toner image melts and is fixed to the sheet 9.

The sheet 9 to which the toner image is fixed is ejected by the fixing unit 5, and is placed on the stacker 6. The cleaning blade 27 removes the residual toner or other foreign material from the surface of the belt 21.

### <Configuration of Endless Belt>

In a general printer, there are factors related to a surface roughness of the belt 21 that cause deterioration of image quality. In Embodiment 1, the belt 21 is configured so as to reduce such factors causing deterioration of image quality. A configuration of the belt 21 will be herein described.

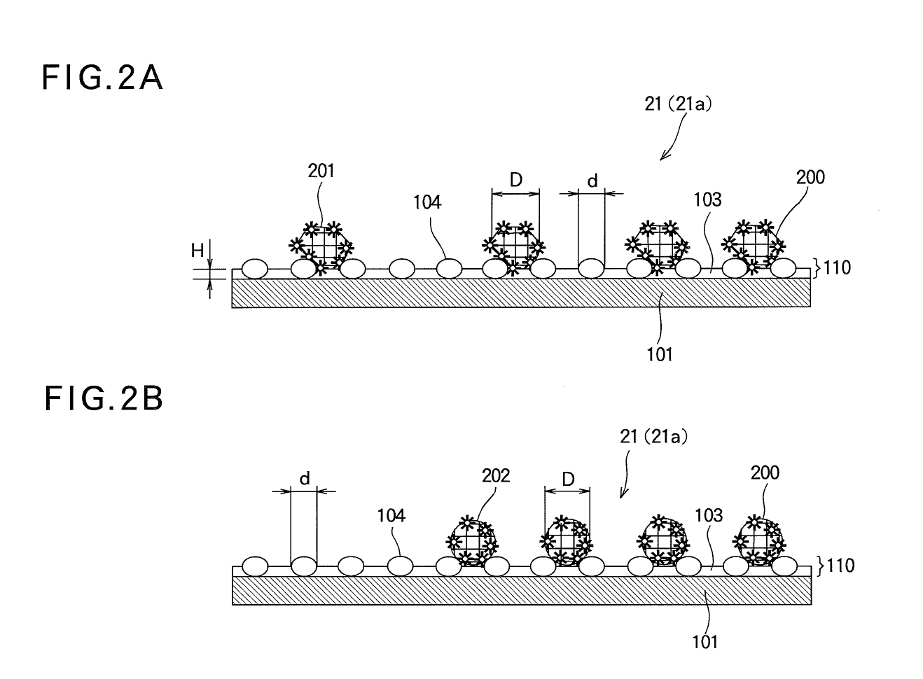

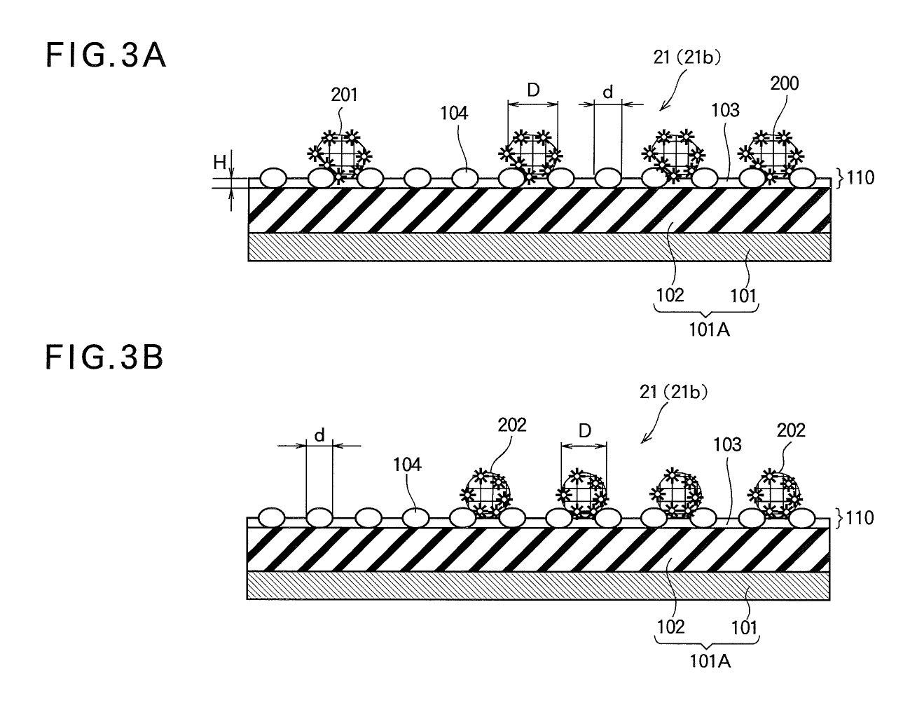

Here, FIGS. 2A and 2B show an example of the belt 21, which is referred to a belt 21a. FIGS. 3A and 3B show another example of the belt 21, which is referred to as a belt 21b. As shown in FIGS. 2A and 2B, the belt 2a has no resilient layer. In contrast, as shown in FIGS. 3A and 3B, the belt 2b has a resilient layer 102. Hereinafter, where it is necessary to distinct the belt 21a and the belt 21b, the belt 21a will be referred to as “the belt 21a with no resilient layer”, and the belt 21b will be referred to as “the belt 21b with the resilient layer”.

Further, a toner 201 (FIGS. 2A and 3A) and a toner 202 (FIGS. 2B and 3B) of two kinds are prepared. The toner 201 is produced by pulverization method, and has low sphericity. In contrast, the toner 202 is produced by emulsion polymerization method, and has high sphericity. Hereinafter, where it is necessary to distinct the toner 201 and the toner 202, the toner 201 will be referred to as “the pulverization toner 201”, and the toner 202 will be referred to as “the spherical toner 202”.

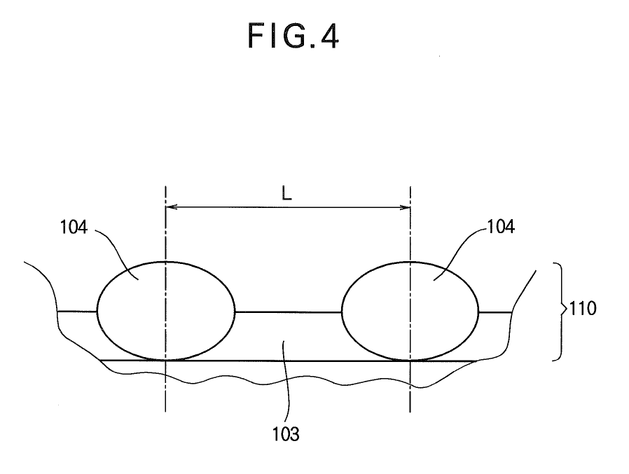

Hereinafter, description will be made of configurations of the belts 21a and 21b as examples of the belt 21 of the Embodiment 1. FIGS. 2A and 2B are schematic sectional views showing a configuration of the belt 21a with no resilient layer. FIGS. 3A and 3B are schematic sectional views showing a configuration of the belt 21b with the resilient layer 102. FIG. 4 is a schematic view showing roughness-imparting particles 104 of the belt 21 (21a, 21b) described later.

As shown in FIGS. 2A and 2B, the belt 21a (with no resilient layer) has a belt substrate 101 on an inner circumference thereof. The belt 21a further includes a binder layer 103 formed on a surface (i.e., an outer circumference) of the belt substrate 101. Roughness-imparting particles 104 are fixed to the binder layer 103. The roughness-imparting particles 104 are provided for forming concaves and convexes on the surface of the belt 21a. The binder layer 103 and the roughness-imparting particles 104 constitute a surface layer 110 of the belt 21a. As shown in FIG. 4, the roughness-imparting particles 104 are arranged at a pitch (i.e., an average pitch) L on the belt substrate 101. In other words, adjacent roughness-imparting particles 104 are distanced from each other by the pitch L. With such a configuration, the belt 21a (with no resilient layer) has convexes and concaves on the surface of the surface layer 110 due to the roughness-imparting particles 104.

In this regard, it is preferred that the pitch L of the roughness-imparting particles 104, a mean particle diameter D of the toner, and a mean particle diameter d of the roughness-imparting particles 104 satisfy the following relationship: L≦D+d.

To be more specific, an effect can be obtained when the roughness-imparting particles 104 (of the surface layer 110) in the number of 100 to 1000 are disposed in an area of 100 μm square. This is equivalent to a case where the roughness-imparting particles 104 in the number of 10,000 to 100,000 are disposed in an area of 1 mm square (i.e., 1 mm²).

Further, it is more preferable that the roughness-imparting particles 104 in the number of 300 to 800 are disposed in the area of 100 μm square. This is equivalent to a case where the roughness-imparting particles 104 in the number of 30,000 to 80,000 are disposed in the area of 1 mm square (i.e., 1 mm²).

As shown in FIG. 2A, when the belt 21a (with no resilient layer) is used with the pulverization toner 201 as the toner 200, the pulverization toner 201 adheres to the surface layer 110 between the roughness-imparting particles 104. As shown in FIG. 2B, when the belt 21a (with no resilient layer) is used with the spherical toner 202 as the toner 200, the spherical toner 202 adheres to the surface layer 110 between the roughness-imparting particles 104.

As shown in FIGS. 3A and 3B, the belt 21b (with the resilient layer 102) has a belt substrate 101 on an inner circumference thereof. The belt 21b further includes the resilient layer 102 formed on a surface (i.e., an outer circumference) of the belt substrate 101, and a binder layer 103 formed on the resilient layer 102. The resilient layer 102 has a predetermined resiliency. Roughness-imparting particles 104 are fixed to the binder layer 103. As shown in FIG. 4, the roughness-imparting particles 104 are arranged at a pitch (i.e., an average pitch) L in a similar to the surface layer 110 of the belt 21a having no resilient layer. With such a configuration, the belt 21b (with the resilient layer 102) has convexes and concaves on the surface of the surface layer 110 due to the roughness-imparting particles 104.

As shown in FIG. 3A, when the belt 21b (with the resilient layer 102) is used with the pulverization toner 201 as the toner 200, the pulverization toner 201 adheres to the surface layer 110 between the roughness-imparting particles 104. As shown in FIG. 3B, when the belt 21a (with the resilient layer 102) is used with the spherical toner 202 as the toner 200, the spherical toner 202 adheres to the surface layer 110 between the roughness-imparting particles 104.

<Producing Method of Belt with No Resilient Layer>

A producing method of the belt 21a with no resilient layer (FIGS. 2A and 2B) will be described.

(1) First, the belt substrate 101 (also referred to as a belt substrate layer 101) is formed. As an example, the belt substrate 101 is formed using an extrusion molding. A forming method of the belt substrate 101 is not limited to the extrusion molding. For example, the belt substrate 101 can be formed using inflation molding, injection molding, centrifugal molding, dip molding or the like.

(1-1) First, a resin for forming the belt substrate 101 is prepared. More specifically, carbon black (for imparting electrical conductivity) of a suitable amount is added to polyamide-imide (PAI), and mixed and agitated in a solution of N-methylpyrrolidone (NMP), so that a resin as a material of the belt substrate 101 is obtained. In this example, PAI has Young's modulus in a range from 2.0 GPa to 5.5 GPa, and more preferably in a range from 3.0 GPa to 5.0 GPa.

(1-2) Next, the resulting resin is poured into a cylindrical mold. Then, the resin is heated to a predetermined temperature in a range from 80 to 120° C. for a predetermined time period while rotating the cylindrical mold. Further, the resin is heated to a predetermined temperature in a range from 200 to 350° C. for a predetermined time period, and then the resin is taken out from the cylindrical mold. In this regard, the resin is taken out from the cylindrical mold by being continuously extruded from a nozzle of the cylindrical mold. As a result, a demolded belt substrate (which is to be the belt substrate 101) of PAI having a predetermined size is obtained. In this example, the demolded belt substrate has a thickness of 100±10 (μm) and an inner circumferential length 624±1.5 (mm). These dimensions of the demolded belt substrate are determined by adjusting settings of the nozzle of the cylindrical mold.

(1-3) The demolded belt substrate has a width corresponding to widths of a plurality of the belts 21a. Therefore, the demolded belt substrate is cut into a predetermined width (which is the same as the width of the belt 21a). As a result; the belt substrate 101 having the predetermined width is obtained. In this example, the belt substrate 101 having a thickness of 100±10 (μm), an inner circumferential length 624±1.5 (mm) and a width of 228±0.5 (mm) is obtained.

(2) Next, a material for forming the surface layer 110 (referred to as a surface layer material) of the belt 21a is coated onto the surface of the belt substrate 101. As an example, a spray coating is used for coating the surface layer material.

(2-1) First, the surface layer material is prepared. More specifically, acryl particles (as the roughness-imparting particles 104) of a suitable amount are added to urethane-based aqueous coating material (as the binder layer 103), so as form the surface layer material.

In this regard, various kinds of particles can be used as the roughness-imparting particles 104. For example, it is also possible to use silica (SiO₂), polyester resin, acrylic resin, fluoride resin, silicone resin and the like alone or in combination.

Further, if a free surface energy of the roughness-imparting particles 104 is small, adhesiveness between the roughness-imparting particles 104 and the particles of the toner 200 decreases. For this reason, it is preferred to use roughness-imparting particles whose free surface energy is large.

It is preferred to suitably adjust the adding amount of the roughness-imparting particles 104 based on the mean particle diameter D of the toner 200 (FIGS. 2A to 3B) and a coating method of the surface layer material containing the roughness-imparting particles 104. Further, it is preferred to set the adding amount of the roughness-imparting particles 104 so as to reduce contact areas between the binder layer 103 and the toner 200.

(2-2) Next, the belt substrate 101 is set in a mold, and the surface layer material is coated on an outer circumference of the belt substrate 101 using a spray coating. With this process, the binder layer 103 is formed on the surface of the belt substrate 101. In this state, the roughness-imparting particles 104 are fixed to the belt substrate 101. The binder layer 103 and the roughness-imparting particles 104 constitute the surface layer 110. As a result, the belt 21a having no resilient layer is produced.

The resulting belt 21a has a total thickness which is a sum of the thickness of the belt substrate 101 (100±10 μm) and the thickness of the binder layer 103. The belt 21a has an outer circumferential surface of 624±1.5 mm, and a width of 228±0.5 mm.

In this regard, a method for coating the surface layer material is not limited to the spray coating method. It is also possible to use the roll coating method, a bar-coating method, a dip coating method or the like. Optionally, in order to enhance adhesiveness between the surface layer 110 (i.e., the binder layer 103 and the roughness-imparting particles 104) and the belt substrate 101, it is possible to coat a surface treatment agent (i.e., a primer) on the outer circumferential surface of the belt substrate 101. The thickness of the surface layer 110 can be adjusted by adjusting a density of the surface layer material, an amount of coating of the surface layer material or the like.

In Embodiment 1, the surface roughness of the belt is not adjusted by grinding, but is adjusted by the coating of the roughness-imparting particles 104. The reason is as follows. When grinding is performed on a soft object, it is difficult to obtain accuracy of the surface of the object, and it is difficult to control a formation of the object. In contrast, by coating the roughness-imparting particles 104 on a soft material, it becomes possible to obtain a surface having a uniform roughness with accuracy on a wide area of the object, and it is possible to control a formation of the object.

### <Producing Method of Belt Having Resilient Layer>

A producing method of the belt 21b (FIGS. 3A and 3B) with the resilient layer 102 will be described.

(1) First, the belt substrate 101 is formed. Here, the belt substrate 101 is formed in a similar manner as the belt substrate 101 of the belt 21a. In this regard, the belt substrate 101 is cut into a width of the belt 21b after the resilient layer 102 is formed.

(1-1) First, a resin for forming the belt substrate 101 is prepared as described in the producing method of the belt 21a.

(1-2) Then, the resin is poured into the cylindrical mold, and is heated to a predetermined temperature in a range from 80 to 120° C. for a predetermined time period. Then, the resin is heated to a predetermined temperature in a range from 200 to 350° C. for a predetermined time period, and the resin is taken out from the cylindrical mold. In this regard, the resin is taken out from the cylindrical mold by being continuously extruded from a nozzle of the mold. As a result, the belt substrate 101 of PAI having a predetermined size is obtained. In this example, the belt substrate has a thickness of 100±10 (μm) and an inner circumferential length 624±1.5 (mm).

(2) Next, the resilient layer 102 is formed on the belt substrate 101.

(2-1) First, a resin for forming the resilient layer 102 is prepared. More specifically, ion conductor (for imparting electrical conductivity) of a suitable amount is added to thermoplastic polyurethane, so as to obtain the resin for forming the resilient layer 102.

(2-2) Next, the resin is poured into the cylindrical mold, and is heated to a predetermined temperature in a range from 90 to 100° C. for a predetermined time period while rotating the cylindrical mold. Then, the belt substrate 101 is inserted into the cylindrical mold so as to cause the resin and the belt substrate 101 to adhere to each other. Then, the resin and the belt substrate 101 are heated to a predetermined temperature in a range from 100 to 120° C. for a predetermined time period, and the resin and the belt substrate 101 are taken out from the cylindrical mold. With this process, the belt substrate 101 integrated with the resilient layer 102 (i.e., an original tube) is obtained.

The original tube has a width corresponding to widths of a plurality of the belts 21b. In this example, the original tube has a thickness of 300±30 (μm) and an inner circumferential length 624±1.5 (mm). These dimensions of the original tube are determined by adjusting the settings of the nozzle of the cylindrical mold.

(2-3) Since the original tube has a width corresponding to widths of a plurality of the belts 21b, the original tube is cut into a predetermined width (which is the same as the width of the belt 21b). As a result, the belt substrate 101 having the predetermined width is obtained. More specifically, the belt substrate 101 with the resilient layer 102 (referred to as a belt resilient substrate 101A) having a width of the belt 21b is obtained. In this example, the belt resilient substrate 101A has a thickness of 100±10 (μm), an inner circumferential length 624±1.5 (mm) and a width of 228±0.5 (mm) is obtained.

(3) Then, a surface layer material is coated on the belt resilient substrate 101A. In this example, the surface layer material is coated on the belt resilient substrate 101A in a similar manner as described with respect to the belt 21a.

(3-1) First, the surface layer material (to be coated on the belt resilient substrate 101A) is prepared in a similar manner as described with respect to the belt 21a.

(3-2) Then, the belt resilient substrate 101A is set in a mold, and the surface layer material is coated on the outer circumferential surface of the belt resilient substrate 101A. With this process, the binder layer 103 is formed on the surface of the belt resilient substrate 101A. In this state, the roughness-imparting particles 104 are fixed to the binder layer 103. The binder layer and the roughness-imparting particles 104 constitute the surface layer 110. As a result, the belt 21b having the resilient layer 102 is produced.

The resulting belt 21b has a total thickness which is a sum of the thickness of the belt resilient substrate 101A (300±30 μm) and the thickness of the binder layer 103. The belt 21b has an inner circumferential length of 624±1.5 mm, and a width of 228±0.5 mm.

### <Supplemental Explanation>

In Embodiment 1, the belt substrate 101 is composed of PAI. PAI has a series of chemical structures in each of which an amide group is linked to one or two imide groups are via an organic group.

PAI is classified into fatty series and aromatic series depending on whether the organic group is fatty series or aromatic series. In terms of bending durability and mechanical characteristics, it is preferred to use aromatic series PAI. The aromatic series is an organic compound in which an organic group linking an imide group and an amide group takes the form of one or two benzene rings.

PAI may be an imide ring-closure or amide acid before imide ring-closure. In Embodiment 1, it is preferred that imidation ratio is higher than or equal to 50%, and more preferably 70%. This is because the PAI containing a large amount of amide acid before imide ring-closure may exhibit relatively large dimension changes.

The imidation ratio is measured using Fourier transform infrared ray spectroscopy (FT-IR). The imidation ratio is specified based on a ratio of an intensity of infrared ray at an absorption peak (1780 cm⁻¹) associated with imide group to an intensity of infrared ray at an absorption peak (1510 cm⁻¹) associated with benzene rings.

Generally, when the belt substrate 101 has a molecular structure containing a large amount of aromatic rings or imide groups, Young's modulus of the belt substrate 101 can be increased. In contrast, when the belt substrate 101 has a molecular structure containing a small amount of aromatic rings or imide groups, Young's modulus of the belt substrate 101 can be reduced.

A material of the belt substrate 101 is not limited to PAI. In terms of bending durability and mechanical characteristics, the belt 21 is preferably made of a material with which a tension is within a predetermined range when the belt 21 moves, and with which the belt 21 is least subject to damage (wear at side ends, bending or breaking) when the belt 21 repeatedly slides with skew preventing member (i.e., the guide members).

The material of the belt 21 is not limited to above described PAI. For example, materials having Young's modulus of larger than or equal to 2.0 GPa (and more preferably larger than or equal to 3.0 GPa), and smaller than 5.5 GPa (and more preferably smaller than 5.0 GPa). Such materials include polyimide (PI), polycarbonate (PC), polyamide (PA), polyetheretherketone (PEEK), polyvinylidene fluoride (PVdF), ethylene tetrafluoroethylene (ETFE), and mixtures based on these resins.

When the belt 21 is manufactured using a rotational molding, a solvent may be selected as appropriate based on a material to be used. An organic solvent is generally used. In particular, above described NMP, N,N-dimethyl-acetamides can be used as the solvent. It is also possible to use dimethyl sulfoxide, pyridine, tetramethylene sulfone, and dimethyltetramethylene sulfone and the like. These solvents may be used alone or in combination.

In this regard, N,N-dimethyl-acetamides include, for example, N,N-dimethylformamides, N,N-dimethylacetamides, N,N-diethylformamide, N,N-diethylacetamides and the like.

A rotational speed of the cylindrical mold in the rotation molding is in a range from 5 to 1000 rpm (and more preferably in a range from 10 to 500 rpm) in terms of accuracy of the thickness and profile of the thickness of the belt 21.

As a method for forming the belt 21, it is possible to use a cylindrical mold having a larger diameter and another cylindrical mold having a smaller diameter in combination with each other. In such a method, the belt 21 is formed in a gap between the two cylindrical molds. It is also possible to form the belt 21 by applying the material of the belt 21 to an outer circumferential surface of the cylindrical mold by coating or dipping. Even when any method is selected, the material of the belt 21 and producing conditions are the same.

Further, the belt 21 can also be formed by the above described extrusion molding method or inflation molding method. Using these methods, the belt 21 can be formed without using solvents, or the belts 21 of different material can be formed at the same time.

As carbon black contained in the belt substrate 101, it is possible to use, for example, furnace black, channel black, ketjen black, acetylene black and the like. These materials may be used alone or in combination.

The kind of the carbon black is appropriately selected according to a desired conductivity. In Embodiment 1, it is preferred to use furnace black and channel black. Further, carbon black may be preferably subjected to oxidation treatment or graft treatment, or subjected to treatment for enhancing dispersion into solvent.

The amount of carbon black may be selected depending on the kind of carbon black and purpose of carbon black. The endless belt of Embodiment 1 contains carbon black in an amount from 3 to 40 wt % and more preferably from 5 to wt % (further preferably from 5 to 25 wt %) based on solid content in terms of sufficient mechanical strength.

The surface layer 110 is preferably composed of a resilient material having uniform electrical resistance and having ion conductivity. As the resilient material, it is possible to use, for example, conventional ion conductive rubber, elastomer, rubber with ion conductive agent, and the like.

As the ion conductive agent, it is preferred to use a rubber material having polar groups in composition: For example, it is possible to use acrylonitrile butadiene rubber, epichlorohydrin rubber, chloroprene rubber, acrylic rubber, polyurethane rubber, polyurethane elastomer and the like.

In particular, it is preferred to use polyurethane rubber or polyurethane elastomer. This is because the polyurethane rubber and polyurethane elastomer do not ooze out from the belt 21 as plasticizing agent does. Therefore, components (for example, photosensitive drums 11 or the like) contacting the belt 21 do not get dirty even when the belt 21 is used for a long time in the printer 1.

For example, in order to prevent the components contacting the belt 21 from getting dirty during long time use of the printer 1, it is not preferable that the belt 21 contains plasticizing agent or other substance that is likely to ooze out. In view of this, since polyurethane rubber and polyurethane elastomer do not ooze out from the belt 21 as the plasticizing agent does, components contacting the belt 21 are prevented from getting dirty.

For example, as ion conductive agent, it is possible to use ammonium salt. It is also possible to use perchlorate, chlorate, hydrochloride, bromate, iodate, ammonium fluoroborate, hydrosulfate, alkyl sulfate, carboxylic salt, trifluoromethyl sulfate, sulfonate, bis-trifluoromethane-sulfonyl-imide of alkali metal or alkali earth metal and the like. These materials may be used alone or in combination.

As ion conductive agent, it is possible to use, for example, tetraethyl-ammonium, tetrabutyl-ammonium, dodecyl-trimethyl-ammonium, octadecyl-trimethyl-ammonium, octadecyl-trimethyl-ammonium, hexadecyl-trimethyl-ammonium, benzyl-trimethyl-ammonium, modified aliphatic dimethyl-ethyl-ammonium and the like.

As alkali metal and alkali earth metal, it is possible to use, for example, lithium, sodium, potassium, calcium, magnesium and the like.

The resilient layer 102 may contain electron conductive agent such as carbon black and the like.

Depending on the forming method of the resilient layer 102, there is a case where resin of the resilient layer 102 is diluted with solvent. As the solvent, it is possible to use, for example, aromatic-base solvent, ester-base solvent, keton-base solvent such as methyl-ethyl-ketone and acetone, amide-base solvent and the like. These solvents may be used alone or in combination.

As the aromatic-base solvent, it is possible to use, for example, toluene and xylene and the like. As the ester-base solvent, it is possible to use, for example, butyl acetate, isopropyl acetate, ethyl acetate and the like. As the amide-base solvent, it is possible to use, for example, N,N-dimethyl-formamide, N,N-dimethyl-acetamide and the like.

A material of the binder layer 103 is not limited, as long as the material has non-adhesiveness. As the material of the binder layer 103, it is possible to use, for example, fluoro-rubber, fluoro-resin, acrylic resin, polyurethane resin, acrylic urethane resin, silicone resin and the like. These materials may be used alone or in combination.

As the fluoro-rubber, it is possible to use, for example, vinylidene fluoride fluororubber (FKM), tetrafluoro ethylene/propylene rubber (FEPM), tetrafluoro ethylene-perfluoro vinyl ether (FFKM) and the like.

As the fluoro resin, it is possible to use, for example, tetra fluoro ethylene-perfluoro alkylvinyl ether copolymer (PFA), fluorinated ethylene propylene (FEP), polytetrafluoro ethylene (PTFE), polyvinylidene fluoride (PVDF), tetrafluoroethylene-hexafluoropropylene-vinylidene fluoride (THV) and the like.

The acrylic resin is a polymer having acrylic group. As the acrylic resin, it is possible to use acrylate ester, methacrylate ester and the like.

As the polyurethane resin, it is possible to use, for example, polyester-base urethane resin having an ester bond in a main chain, polyether-base urethane resin having an ether bond in a main chain, and the like.

The silicone resin is a polymer having siloxane bond in a main chain.

The producing method of the belt 21 is not limited to the above described method. The belt 21 can also be produced using the following method. For example, the belt 21 can be produced by forming the surface layer 110, the resilient layer 102 and the belt substrate 101 using centrifugal molding in this order. Alternatively, the belt 21 can be produced by forming the resilient layer 102 and the belt substrate. 101 using centrifugal molding in this order, taking out a molded material from the mold, and coating the surface layer 110 on the molded material. Further, the belt 21 can be produced by forming the belt substrate 101 using centrifugal molding, taking out a molding material (i.e., the belt substrate 101) from the mold, and coating the resilient layer 102 and the surface layer 110 on the belt substrate 101 in this order.

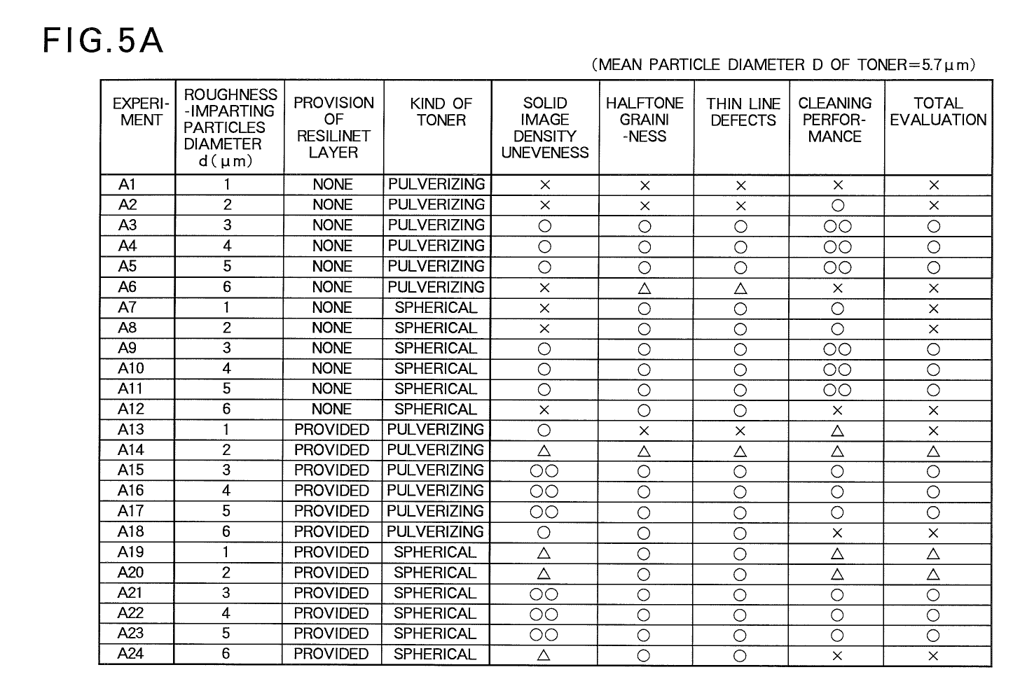

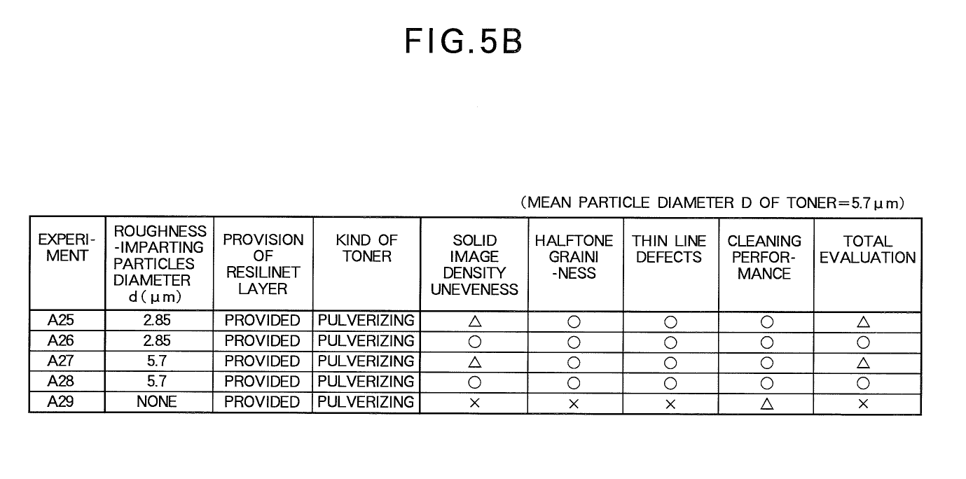

The belt 21 is so configured that the surface layer 110 has concaves and convexes formed by the roughness-imparting particles 104. As a result of experiments shown in FIGS. 5A and 5B described later, it is found that high image quality is obtained when the mean particle diameter d of the roughness-imparting particles 104 of the surface layer 110 and the mean particle diameter D of the toner 200 (here, the pulverization toner 201 and the spherical toner 202) satisfy the following inequality (1):

(½)×D<d<D (1)

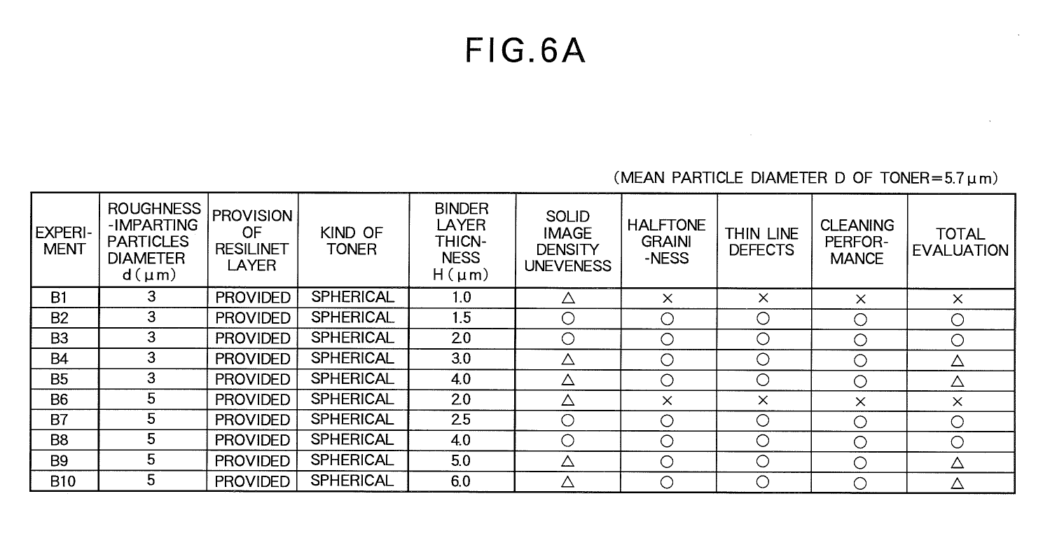

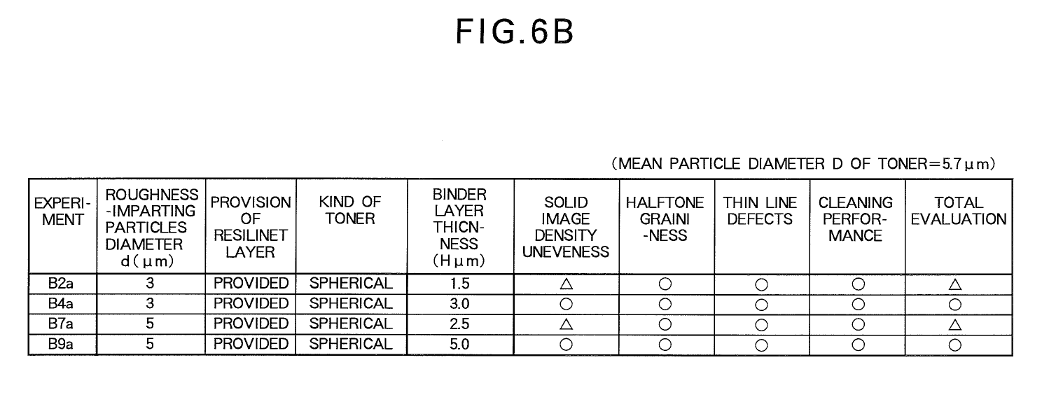

Further, as a result of experiments shown in FIGS. 6A and 6B described later, it is found that high image quality is obtained when the mean particle diameter d of the roughness-imparting particles 104 and a thickness H of the binder layer 103 satisfy the following inequality (2):

(½)×d<H<d (2)

The mean particle diameter d of the roughness-imparting particles 104 and the mean particle diameter D of the toner 200 are measured as follows. The mean particle diameter (i.e., mean volume diameter) d of the roughness-imparting particles 104 is measured using a cell counter/analyzer “Coulter Multisizer III” (manufactured by Beckman Coulter Co., Ltd.). An aperture diameter of the cell counter/analyzer is set to 100 μm, and a mean volume diameter (μm) of 30000 particles (the roughness-imparting particles 104) is determined. Similarly, the mean particle diameter D of the toner 200 is measured using the cell counter/analyzer “Coulter Multisizer III” (manufactured by Beckman Coulter Co., Ltd.). The aperture diameter of the cell counter/analyzer is set to 100 and mean volume diameter (μm) of 30000 particles of the toner 200 is measured.

### <Experiments>

Experiments to determine an optimum configuration of the belt 21 according to Embodiment 1 will be described with reference to FIGS. 5A, 5B, 6A and 6B. FIGS. 5A, 5B, 6A and 6B show experimental results using the belt 21 according to Embodiment 1.

Experiments were performed using the pulverization toner 201 (see, FIGS. 2A and 3A) and the spherical toner 202 (see, FIGS. 2B and 3B). The producing method of the pulverization toner 201 and the spherical toner 202 will be described.

### <Producing Method of Pulverization Toner>

Particles of the pulverization toner 201 are mainly composed of polyester. The particles of the pulverization toner 201 are formed by pulverization method. Further, the resulting particles are mixed with fine particles of silica or titanium oxide, and are agitated using a mixer. In the experiments, the pulverization toner 201 having a mean particle diameter of 5.7 μm was used. The particles of the pulverization toner 201 have irregular shapes, and therefore sphericity is not defined.

### <Producing Method of Spherical Toner>

Particles of the spherical toner 202 are mainly composed of styrene-acryl copolymer and contain paraffin wax in an amount of 9 weight parts. The particles of the spherical toner 202 are formed by mixing styrene-acryl copolymer and paraffin wax by emulsion polymerization method. Further, the resulting particles are mixed with fine particles of silica or titanium oxide, and are agitated using a mixer. In the experiments, the spherical toner 202 having a mean particle diameter of 5.5 μm and sphericity of 0.95 was used. In this regard, as the value of sphericity is closer to 1.00, the shape of the particle is closer to sphere.

The emulsion polymerization method is as follows. First, primary particles are formed of mixing styrene-acryl copolymer (i.e., a binder resin of the spherical toner 202) in solvent. Then, coloring agent (emulsified using surfactant as emulsifier) is mixed with the primary particles in the same solvent. Further, if necessary, wax or charge controlling agent or the like is mixed with the resulting particles. Then, the resulting particles are aggregated. The particles of the spherical toner 202 are taken out of the solvent, cleaned and dried, so that unnecessary solvent component or by-products are removed.

### <Specification of Printer Used in Experiments>

In the embodiments, a printer “C910” manufactured by Oki Data Corporation was used. Although the printer “C910”was originally configured as a color printer of a direct transfer type, the printer “C910” was modified to a color printer of an intermediate transfer type for the experiments.

The toners 201 and 202 used in the experiments had the mean particle diameter (i.e., mean volume diameter) of 5.7 μm, and contained particles whose diameters are in a range from 5.3 to 6.1 μm.

The sheets 9 of A4 size were used as the recording media. Three kinds of images, i.e., a black solid image, a halftone image and a thin line image were printed on the sheets 9.

In each of the belts 21a and 21b, the roughness-imparting particles 104 were coated on the surface having a ten-point surface roughness Rz of less than or equal to 5 μm. More specifically, in the belt 21a having no resilient layer, the belt substrate 101 had a ten-point surface roughness Rz of less than or equal to 5 μm. In the belt 21b having the resilient layer 102, the resilient layer 102 had a ten-point surface roughness Rz of less than or equal to 5 μm. The ten-point surface roughness Rz was measured with respect to a reference length of 0.8 mm as defined in JIS (Japanese Industrial Standard).

A speed (i.e., a linear velocity) of the belt 21 was set to 90 mm/sec. In the printer 1 used in the experiments, each of the driving roller 22 and the driven rollers 23 and 24 had a diameter of 25 mm. In this regard, the driving roller 22 and the driven rollers 23 and 24 of Embodiment 1 is not limited to such diameter. In a general printer 1, the diameters of the driving roller 22 and the driven rollers 23 and 24 are in a range from 10 to 50 mm in terms of reduction in cost and size.

In the printer 1 used in the experiments, the belt was stretched around the driving roller 22 and the driven rollers 23 and 24, and was applied with a stretching force applied to 6 kg±10% by a spring. However, a configuration for stretching the belt 21 is not limited to this. The stretching force applied to the belt 21 is appropriately set based on a material of the belt 21 and a mechanism for moving the belt 21. Generally, the stretching force applied to the belt 21 is 8 kg±10%.

The cleaning blade 27 used in the experiments was formed of urethane rubber having a rubber hardness of JIS_A 72° and a thickness of 1.5 mm. A contact linear pressure of the cleaning blade 27 was set to 4.3 g/mm. Use of a resilient body such as urethane rubber or the like is excellent in removing the residual toner and foreign matters, simple in structure, compact in size, and low in cost. As the material of the cleaning blade 27, urethane rubber is most preferable since the urethane rubber has high hardness and resiliency, and is excellent in abrasion resistance, mechanical strength, oil resistance, ozone resistance and the like.

Generally, urethane rubber of the cleaning blade 27 preferably has hardness in a range from JIS_A 60° to 90°, and more preferably in range from JIS_A 70° to 85°, in order to obtain sufficient cleaning performance. A breaking elongation of the urethane rubber is preferably in a range from 250 to 500%, and more preferably in a range from 300 to 400%. A permanent elongation of the urethane rubber is preferably in a range from 1.0 to 5.0%, and more preferably in a range from 1.0 to 2.0%. A rebound resilience of the urethane rubber is preferably in a range from 10 to 70%, and more preferably in a range from 30 to 50%. These characteristics are measured in accordance with JIS_K6301.

A contact pressure (i.e., a linear pressure) between the cleaning blade 27 and the belt 21 is preferably in a range from 1 to 6 g/mm, and more preferably in a range from 2 to 5 g/mm. This is because if the contact pressure is too low, a force with which the cleaning blade 27 presses the belt 21 becomes insufficient, and may cause a cleaning failure (i.e., a phenomenon where the cleaning blade 27 cannot remove the residual toner from the belt 21). Further, if the contact pressure is too high, he cleaning blade 27 and the belt 21 contact each other at surfaces, and may increase friction resistance, which may cause filming phenomenon where the toner sticks to the belt 21 by the pressing force or may cause peeling of the cleaning blade 27.

### <Experiments>

As a first series of experiments, experiments A1 through A24 shown in FIG. 5A were performed. The experiments A1 through A6 were performed using the belt 21a with no resilient layer and the pulverization toner 201. The mean particle diameter d of the roughness-imparting particles 104 of the belt 21a was varied to 1, 2, 3, 4, 5 and 6 μm.

The experiments A7 through A12 were performed using the belt 21a with no resilient layer and the spherical toner 202. The mean particle diameter d of the roughness-imparting particles 104 of the belt 21a was varied to 1, 2, 3, 4, 5 and 6 μm.

The experiments A13 through A18 were performed using the belt 21b with the resilient layer 102 and the pulverization toner 201. The mean particle diameter d of the roughness-imparting particles 104 of the belt 21b was varied, to 1, 2, 3, 4, 5 and 6 μm.

The experiments A19 through A24 were performed using the belt 21b with the resilient layer 102 and the spherical toner 202. The mean particle diameter d of the roughness-imparting particles 104 of the belt 21b was varied to 1, 2, 3, 4, 5 and 6 μm.

As a second series of experiments, experiments B1 through B10 shown in FIG. 6A were performed. The experiments B1 through B5 were performed using the belt 21b (with the resilient layer 102) having the roughness-imparting particles 104 with a mean particular diameter d of 3 μm, and using the spherical toner 202. Further, the thickness H of the binder layer 103 was varied to 1.0, 1.5, 2.0, 3.0 and 4.0 μm.

The experiments B6 through B10 were performed using the belt 21b (with the resilient layer 102) having the roughness-imparting particles 104 with a mean particular diameter d of 5 μm, and using the spherical toner 202. Further, the thickness H of the binder layer 103 was varied to 2.0, 2.5, 4.0, 5.0 and 6.0 μm.

In this regard, the mean particle diameters d (FIGS. 5A, 5B, 6A and 6B) and ranges of diameters of the roughness-imparting particles 104 have the following relationship.

The roughness-imparting particles 104 whose mean particle diameter d is 1 μm contains particles whose diameters are in a range from 0.3 to 1.7 μm.

The roughness-imparting particles 104 whose mean particle diameter d is 2 μm contains particles whose diameters are in a range from 0.6 to 3.4 μm.

The roughness-imparting particles 104 whose mean particle diameter d is 3 μm contains particles whose diameters are in a range from 0.9 to 5.1 μm.

The roughness-imparting particles 104 whose mean particle diameter d is 4 μm contains particles whose diameters are in a range from 1.2 to 6.8 μm.

The roughness-imparting particles 104 whose mean particle diameter d is 5 μm contains particles whose diameters are in a range from 1.5 to 8.5 μm.

The roughness-imparting particles 104 whose mean particle diameter d is 6 μm contains particles whose diameters are in a range from 1.8 to 10.2 μm.

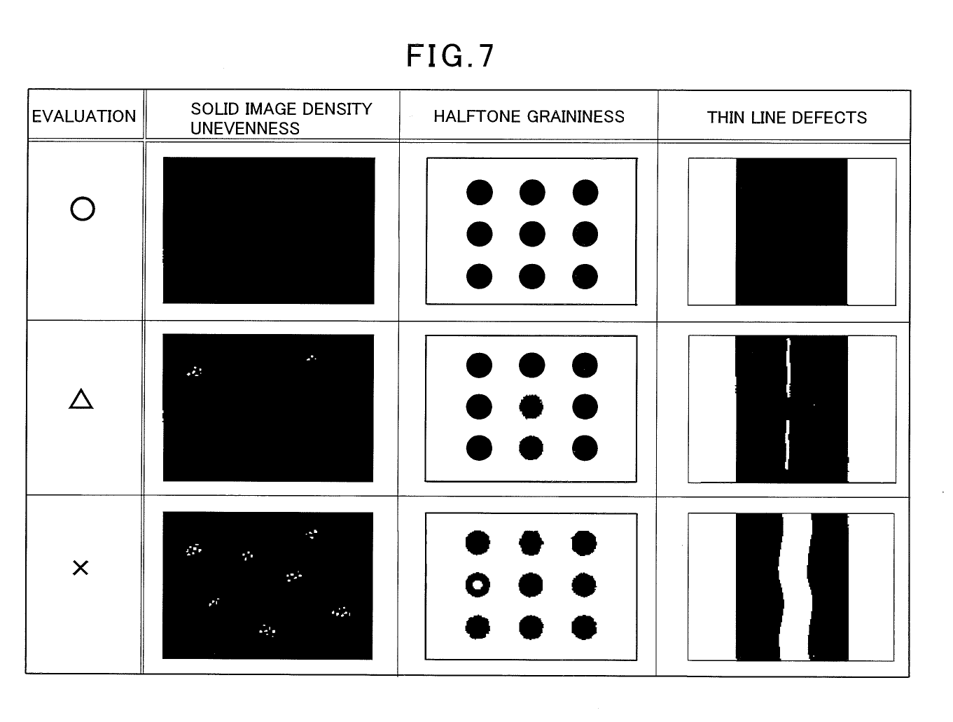

In the experiments, solid image density unevenness (i.e., density unevenness in, a solid image), halftone image graininess (i.e., graininess of a halftone image), thin line defects (i.e., hollow defects in a thin line) and cleaning performance are evaluated. Evaluation criteria will be described with reference to FIG. 7.

FIG. 7 shows the evaluation criteria. As shown in FIG. 7, the solid image density unevenness indicates a phenomenon in which white blanks appear in a solid image. White blanks are generated when the toner does not reach a concave portion of the sheet 9 and the surface of the sheet 9 is partially exposed. The white blanks appear as disturbed portions. The evaluation of the solid image density unevenness is performed by checking presence/absence of the white blanks and degree of the white blanks. When the solid image density unevenness occurs, a disturbed image is printed on the sheet 9.

The halftone image graininess indicates a phenomenon in which dots with high graininess appear in a halftone image. The evaluation of the halftone image graininess is performed by checking the shape of the dots. When the dot has a circular shape, the evaluation result of the halftone image graininess is at an acceptable level. When the dot has a non-circular shape (i.e., distorted from a circular shape) or when the sheet 9 is seen through the dot, the evaluation result of the halftone image graininess is at a non-acceptable level. When the halftone image graininess occurs, blurred image is formed on the sheet 9.

The thin line defects indicate a phenomenon in which hollow defects (i.e., areas with no developer) appear in a thin line image having a width of, for example, 1-2 mm. The hollow defects occur when, for example, the toner 200 separates from the belt 21. When the hollow defects are not found, the evaluation result of the thin line defects is at an acceptable level. When the hollow defects are found, the evaluation result of the thin line defects is at a non-acceptable level. When the thin line defects occur, an inaccurate image is formed on the sheet 9.

The cleaning performance is a performance with which the cleaning blade 27 can remove the residual toner 200 that remains on the belt 21 (after the transferring of the toner image). When the residual toner 200 is sufficiently removed from the belt 21, the evaluation result of the cleaning performance is at an acceptable level. When the residual toner 200 is not sufficiently removed from the belt 21, the evaluation result of the cleaning performance is at a non-acceptable level. When the cleaning performance decreases, a smear image is formed on the sheet 9.

The evaluation results are classified into four levels: i.e., excellent (O), good (O), normal (Δ) and poor (X). The “excellent” (O) and “good” (O) indicate that the image quality is at the acceptable level. The “excellent” (O) is better than “good” (O). The “normal” (Δ) indicates that the image quality is at a practically acceptable level although the solid image density unevenness, the halftone image graininess, the thin line defects or the cleaning failure slightly occurs. The “poor” (X) indicates that the image quality is at the non-acceptable level.

In the experiments, the printing was performed on 10000 sheets. When the image of the non-acceptable level (see, a bottom row of FIG. 7) was found in even one of 10000 sheets, the evaluation result was determined to be “poor” (X). If the image of the non-acceptable level was not observed with naked eyes, but was observed using a microscope at 10-fold magnification, the evaluation result was determined to be “normal” (A).

From the experimental results shown in FIG. 5A, it was found that high image quality was obtained in the experiments A3, A4, A5, A9, A10, All, A15, A16, A17, A21, A22 and A23. That is, high image quality was obtained when the inequality (1), i.e., (½)×D<d<D was satisfied.

In the inequality (1), inequality sign “<” is used instead of “≦”. The reason is as follows. The inequality (1) defines a relative range of the mean particle diameter d of the roughness-imparting particles 104 and the mean particle diameter D of the toner (201, 202). If the inequality is expressed as (½)×D≦d≦D, the mean particle diameters d and D may take critical values of the range (i.e., d=D/2 or d=D). However, there are measurement errors in the mean particle diameters d and D (due to, for example, diameter distributions). Therefore, if the mean particle diameters d and D take critical values of the range (i.e., d=D/2 or d=D), there is a possibility that the inequality may not be satisfied because of the measurement errors. In other words, if the experiments are performed on condition that the mean particle diameters d and D take critical values of the range (i.e., d=D/2 or d=D), satisfactory results may be obtained in some cases, but may not be obtained in other cases. For this reason, inequality sign “<” is used in the inequality (1) instead of “≦”, so as to ensure enhancement in image quality.

For confirmation, experiments A25 through A29 as shown in FIG. 5B were performed. The experiments A25 and A26 were performed using the belt 21b (with the resilient layer 21b) having the roughness-imparting particles 104 with the mean particle diameter d of 2.85 μm (i.e., d=D/2), and using the pulverization toner 201.

The experiments A27 and A28 were performed using the belt 21b (with the resilient layer 21b) having the roughness-imparting particles 104 with the mean particle diameter d of 5.7 μm (i.e., d=D), and using the pulverization toner 201.

The experiments A29 was performed using the belt 21b (with the resilient layer 21b) having no roughness-imparting particles 104, and using the pulverization toner 201.

As shown in FIG. 5B, in the experiments A25 and A26, the belt 21b (with the resilient layer 21b) having the roughness-imparting particles 104 with the mean particle diameter d of 2.85 μm (i.e., d=D/2) and the pulverization toner 201 were used. Although the experiments A25 and A26 were performed under the same conditions, the experiment A25 did not show satisfactory result, but the experiment A26 showed satisfactory result.

Similarly, in the experiments A27 and A28, the belt 21b (with the resilient layer 21b) having the roughness-imparting particles 104 with the mean particle diameter d of 5.7 μm (i.e., d=D) and the pulverization toner 201 were used. Although the experiments A27 and A28 were performed under the same conditions, the experiment A27 did not show satisfactory result, but the experiment A28 showed satisfactory result.

The same experimental results were obtained when performing experiments while varying the mean particle diameter D of the pulverization toner 201 in a range from 5 to 6.5 μm.

In the above described experiments shown in FIGS. 5A and 5B, each of the belts 21a and 21b has the surface with the ten-point surface roughness Rz of 5 μm before the roughness-imparting particles 104 are coated thereon. However, the belts 21a and 21b are not limited to such configuration. As a result of various experiments, it was found that the same experimental results are obtained as long as the ten-point surface roughness Rz is in a range of 1 to 20 μm.

After the roughness-imparting particles 104 satisfying the relationship (½)×D≦d≦D (in this example, 2.85<d<5.7) were coated, the ten-point surface roughness Rz of the belt 21 was in a range from 1.5 μm to 7 μm.

In this regard, the surface of the belt 21 had the ten-point surface roughness Rz of 5 μm before the roughness-imparting particles 104 were coated thereon, which was in the above described range (i.e., 1-20 μm) of the ten-point surface roughness Rz. However, satisfactory result was not obtained in the experiment A29 (FIG. 5B), i.e., when the belt 21 has no roughness-imparting particles 104.

From this result, it was found that enhancement of image quality is not achieved when the belt 21 has no roughness-imparting particles 104. In other words, it was found that enhancement in image quality was achieved by the provision of the roughness-imparting particles 104 of the belt 21.

Further, from the experimental results shown in FIG. 6A, it was found that high image quality was obtained in the experiments B2, B3, B7 and B8. That is, high image quality was obtained when the thickness H of the binder layer 103 and the mean particle diameter d of the roughness-imparting particles 104 satisfied the inequality (2), i.e., (½)×d<H<d.

In the inequality (2), inequality sign “<” is used instead of “≦”. The reason is as follows. The inequality (2) defines a relative range of the thickness H of the binder layer 103 and the mean particle diameter d of the roughness-imparting particles 104. If the inequality is expressed as (½)×d≦H≦d, the thickness H and the mean particle diameter d may take critical values of the range (i.e., H=d/2 or H=d). However, there are measurement errors in the thickness H and the mean particle diameters d. Therefore, if the thickness H and the mean particle diameter d take critical values of the range (i.e., H=d/2 or H=d), there is a possibility that the inequality may not be satisfied because of the measurement errors. In other words, if the experiments are performed on condition that the thickness H and the mean particle diameter d take critical values of the range (i.e., H=d/2 or H=d), satisfactory results may be obtained in some cases, but may not be obtained in other cases. For this reason, inequality sign “<” is used in the inequality (2) instead of “≦”, so as to ensure enhancement in image quality.

For confirmation, experiments B2a, B4a, B7a and B9a as shown in FIG. 6B were performed. The experiments B2a, B4a, B7a and B9a were preformed respectively under the same conditions as the experiments B2, B4, B7 and B9 shown in FIG. 6A. In these experiments, the thickness H of the binder layer 103 and the mean particle diameter d of the roughness-imparting particles 104 satisfied the relationship H=d/2 (B2, B7, B2a and B7a) or H=d (B4, B9, B4a and B9a). The belt 21b had the resilient layer 102.

As shown in FIGS. 6A and 6B, in the experiments B2 and B2a, the mean particle diameter d of the roughness-imparting particles 104 was 3 μm, and the thickness H of the binder layer 103 was 1.5 μm (i.e., H=d/2). The experiment B2 showed satisfactory result, but the experiment B2a did not show satisfactory result.

Similarly, in the experiments B4 and B4a, the mean particle diameter d of the roughness-imparting particles 104 was 3 μm, and the thickness H of the binder layer 103 was 3.0 μm (i.e., H=d). The experiment B4 did not show satisfactory result, but the experiment B4a showed satisfactory result.

In the experiments B7 and B7a, the mean particle diameter d of the roughness-imparting particles 104 was 5 μm, and the thickness H of the binder layer 103 was 2.5 μm (i.e., H=d/2). The experiment B7 showed satisfactory result, but the experiment B7a did not show satisfactory result.

Similarly, in the experiments B9 and B9a, the mean particle diameter d of the roughness-imparting particles 104 was 5 μm, and the thickness H of the binder layer 103 was 5.0 μm (i.e., H=d). The experiment B9 did not show satisfactory result, but the experiment B9a showed satisfactory result.

### <Consideration>

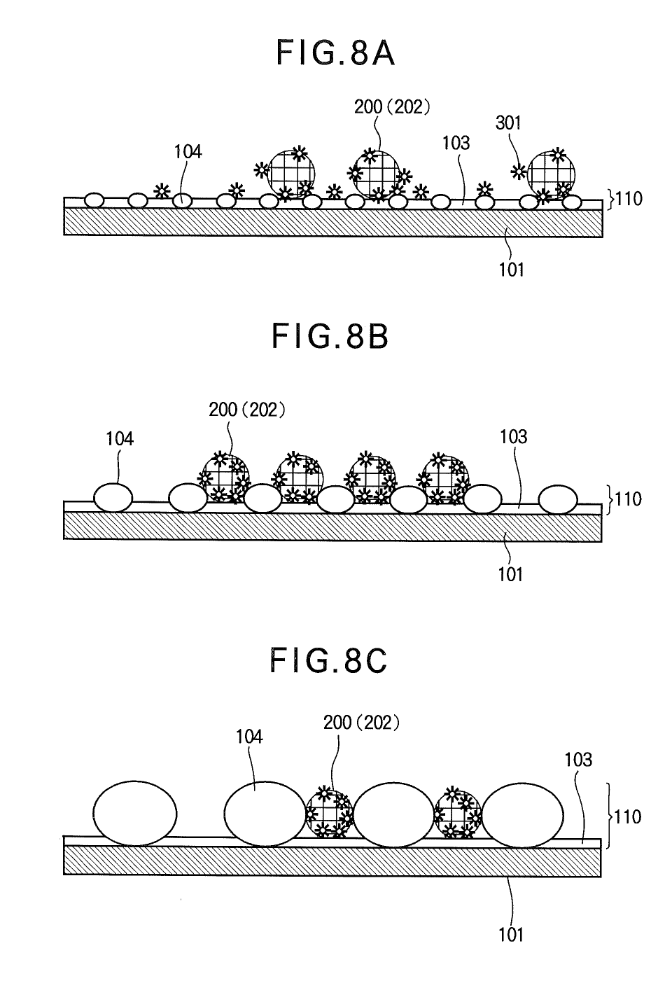

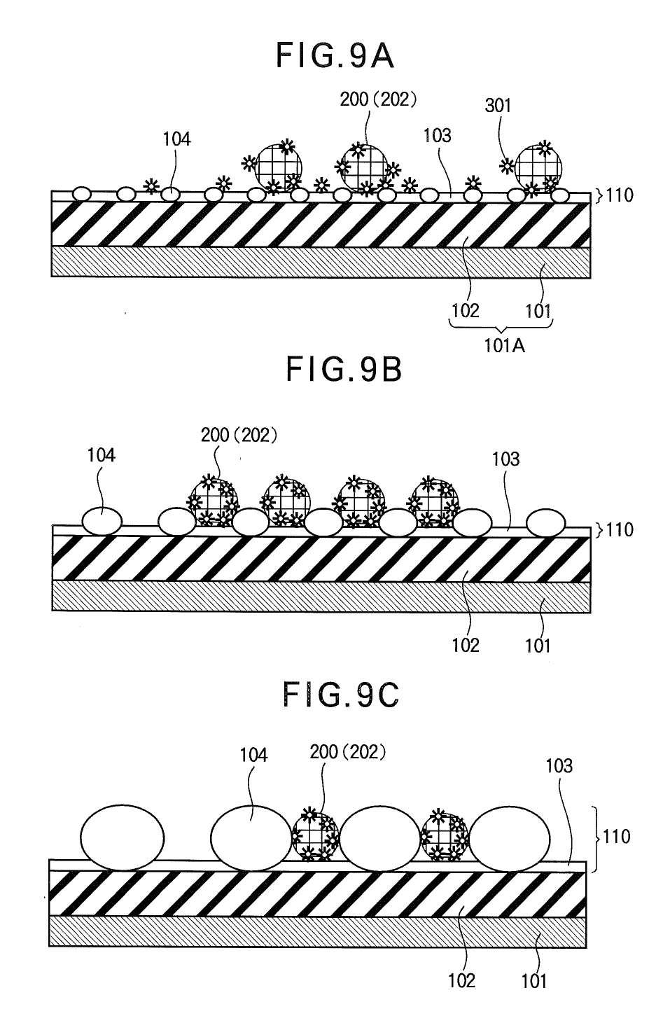

Description will be made of reasons why satisfaction of the inequalities (1) and (2) is preferable, with reference to FIGS. 8A through 9C.

FIGS. 8A, 8B and 8C are schematic views showing how particles of the toner 200 adhere to the belt 21a. FIGS. 9A, 9B and 9C are schematic views showing how particles of the toner 200 adhere to the belt 21b.

Here, description will be made of effects of a configuration satisfying the inequalities (1) and (2). First, as counter-evidence, description will be made of how factors causing deterioration of image quality occur when the inequality (1) or (2) is not satisfied.

### <Enequality (1)>

A first reason why satisfaction of the inequality (1) is preferable will be described with reference to FIG. 8A. FIG. 8A shows a state where the mean particle diameter d of the roughness-imparting particles 104 is smaller than or equal to the lower limit (D/2) of the inequality (1), i.e., d≦D/2. In this case, the roughness-imparting particles 104 tend to drop out from the surface layer 110 of the belt 21, and external additives 301 tend to drop out from the surface of the particles of the toner 200.

More specifically, when the mean particle diameter d of the roughness-imparting particles 104 is smaller than or equal to the lower limit (D/2) of the inequality (1), probability of contact between the belt 21 and the external additives 301 may increase. That is, the belt 21 and the external additives 301 frequently contact each other. Therefore, the roughness-imparting particles 104 may drop out from the surface layer 110, and external additives 301 may drop out from the toner 200. For this reason, when the printer 1 uses the belt 21 having roughness-imparting particles 104 whose mean particle diameter d is smaller than or equal to the lower limit (D/2) of the inequality (1), factors causing deterioration of the image quality (for example, wear of the surface layer 110 of the belt 21, adhesion of the external additives 301 to the surface layer 110 of the belt 21, the insufficient cleaning of the belt 21 and the like) may occur. As a result, the printer 1 may suffer from deterioration of image quality.

A second reason why satisfaction of the inequality (1) is preferable will be described with reference to FIG. 8C. FIG. 8C shows a state where the mean particle diameter d of the roughness-imparting particles 104 is larger than or equal to the upper limit (D) of the inequality (1), i.e., D≦d. In this case, the particles of the toner 200 may be buried in between the roughness-imparting particles 104. For this reason, when the printer 1 uses the belt 21 having roughness-imparting particles 104 whose mean particle diameter d is larger than or equal to the upper limit (D) of the inequality (1), factors causing deterioration of the image quality (for example, insufficient transfer of the toner 200, insufficient cleaning of the belt 21, damage to the cleaning blade 27 and the like) may occur. As a result, the printer 1 may suffer from deterioration of image quality.

FIG. 8B shows a state where the mean particle diameter d of the roughness-imparting particles 104 is in a range defined by the inequality (1). As shown in FIG. 8B, when the mean particle diameter d of the roughness-imparting particles 104 is in the range defined by the inequality (1), i.e., (½)×D<d<D, the above described factors causing deterioration of the image quality can be reduced. Thus, the printer 1 can print an image with high quality.

### <Enequality (2)>

A first reason why satisfaction of the inequality (2) is preferable is as follows. If the thickness H of the binder layer 103 is thinner than or equal to the lower limit (d/2) of the inequality (2), i.e., H≦d/2, the roughness-imparting particles 104 tend to drop out from the surface layer 110 of the belt 21, or the surface layer 110 tends to suffer from wear. In this case, it becomes difficult to maintain a function of the belt 21 to provide a satisfactory image quality, i.e., a function to prevent dropping of the roughness-imparting particles 104 from the surface layer 110 of the belt 21 and to prevent wear of the surface layer 110 of the belt 21.

A second reason why satisfaction of the inequality (2) is preferable is as follows. If the thickness H of the binder layer 103 is thicker than or equal to the lower limit (d) of the inequality (2), i.e., d≦H, the roughness-imparting particles 104 may be buried in the binder layer 103. In this case, it becomes difficult to maintain a function of the belt 21 to provide a satisfactory image quality, i.e., a function to prevent wear of the surface layer 110 of the belt 21, to prevent adhesion of the external additives to the surface layer 110 of the belt 21, to prevent cleaning failure of the belt 21.

Further, from the experimental results shown in FIGS. 5A and 6A, it is found that the belt 21 with the resilient layer 102 is advantageous in suppressing the solid image density unevenness to thereby enhance image quality.

More specifically, as the belt 21 has the resilient layer 102, the surface layer 110 of the belt 21 softly contacts the sheet 9 when the toner image is transferred from the belt 21 to the sheet 9. Therefore, contact area between the belt 21 and the sheet 9 increases, and transferability of the toner image to the sheet 9 is enhanced (even when the sheet 9 has relatively large concaves and convexes).

This is because the resilient layer 102 of the belt 21 suitably releases a pressure from the particles of the toner 200 to the belt 21, and the particles of the toner 200 are not applied with excessive forces. Therefore, the agglomeration of the particles of the toner 200 can be prevented, and the solid image density unevenness can be effectively prevented.

It is particularly advantageous that the belt 21 has the resilient layer 102, when the sheet 9 has a surface with relatively large convexes and concaves (i.e., a paper with a textured surface, a porous paper such as a coarse paper, and the like).

More specifically, the sheet 9 having a surface with relatively large convexes and concaves is not likely to conform to the surface layer 110 of the belt 21 with roughness-imparting particles 104. When the toner image is transferred from the belt 21 to such a sheet 9, the toner may not reach the concave portion of the sheet 9, which may cause white blanks on the printed image. In such a case, the transferability of the toner image can be enhanced by using the belt 21 with the resilient layer 102.

In contrast, the belt 21 having no resilient layer 102 (in which the surface layer 110 is formed on the belt substrate 101) is advantageous in achieving high cleaning performance as shown in FIG. 5A.

As described above, whether the belt 21 is provided with the resilient layer 102 or not is determined based on the desired image quality.

As described above, according to the belt 21 of Embodiment 1, the mean particle diameter d of the roughness-imparting particles 104 and the mean particle diameter of the toner 200 satisfy the relationship: (½)×D<d<D. With such a configuration, occurrence of factors causing deterioration of image quality can be reduced, and therefore high image quality can be achieved.

Further, according to the belt 21 of Embodiment 1, the thickness H of the binder layer 103 and the mean particle diameter d of the roughness-imparting particles 104 satisfy the relationship: (½)×d<H<d. With such a configuration, occurrence of factors causing deterioration of image quality can be further reduced, and therefore higher image quality can be achieved.

### Embodiment 2

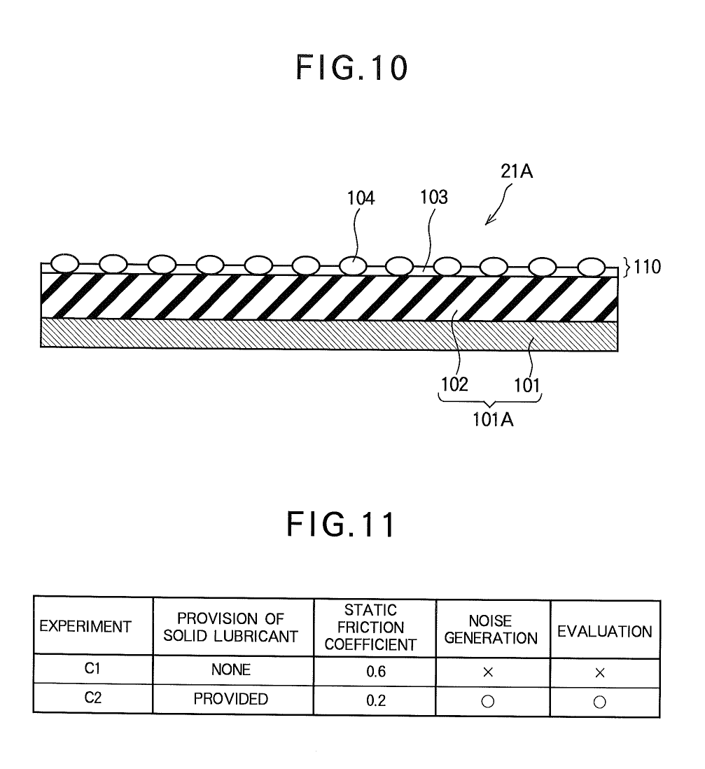

FIG. 10 is a schematic view showing a belt 21A according to Embodiment 2 of the present invention. The belt 21A of Embodiment 2 is different from the belt 21 of Embodiment 1 in that solid lubricant is blended and dispersed in the binder layer 103 of the surface layer 110 of the belt 21A.

The belt 21A of Embodiment 2 will be described. The belt 21A has the same configuration as the belt 21 of Embodiment 1 (FIGS. 2A through 3B). Components of the belt 21A that are the same as or equivalent to those of the belt 21 of Embodiment 1 are assigned the same reference numerals, and duplicate explanations will be omitted. Further, duplicate explanations will be omitted regarding operations and effects of the belt 21A of Embodiment 2 that are the same as those of the belt 21 of Embodiment 1.

In Embodiment 2, the belt 21A has the belt resilient substrate 101A. For example, the belt resilient substrate 101A has a thickness of 300±30 μm, an inner circumferential length 624±1.5 mm, and a width 228±0.5 mm. In this regard, it is also possible to use the belt substrate 101 having no resilient layer 102 (FIGS. 2A and 2B).

The surface layer 110 is formed on the belt resilient substrate 101A. More specifically, a surface layer material is formed by dispersing acryl particles with a mean particle diameter of 3 μm (as the roughness-imparting particles 104) and zinc stearate (as solid lubricant) in urethane-based aqueous coating material (as the binder layer 103). The surface layer material is coated on the belt resilient substrate 101A using spray coating method so that the thickness of the binder layer 103 is 2 μm. With such a process, the belt 21A of Embodiment 2 is produced.

In Embodiment 2, zinc stearate is used as the solid lubricant. However, it is also possible to use metal soap based lubricant such as stearic acid compound, for example, aluminum stearate, barium stearate, calcium stearate, magnesium stearate, lithium stearate, sodium stearate and the like. Appropriate material can be selected in consideration of hardness, temperature limit, solubility and the like.

When experiments were performed on the belt 21A, it was found that the belt 21A (having the binder layer 103 containing solid lubricant) has an advantage that the belt 21A does not generate noise.

Hereinafter, experiments on the belt 21A will be described with reference to FIG. 11. FIG. 11 shows experimental results C1 and C2 using the belt 21 of Embodiment 1 and the belt 21A of Embodiment 2. More specifically, FIG. 11 shows static friction coefficient, generation of noise and evaluation result of quietness.

In FIG. 11, the experiment result C1 was obtained using the printer 1 to which the belt 21 (whose binder layer 103 did not contain solid lubricant) of Embodiment 1 was mounted. The experiment result C2 was obtained using the printer 1 to which the belt 21A (whose binder layer 103 contained solid lubricant) of Embodiment 2 was mounted.

The experiments (i.e., printing test) were performed under an environment (i.e., LL environment) of low temperature (10° C.) and low humidity (20%). Other conditions of experiments and methods for evaluations are the same as those described in Embodiment 1. The static friction coefficient of the surface layer 110 of the belt A) was measured using a measuring instrument “TRIBOGEAR 14FV” manufactured by Shinto Scientific Co., Ltd.

In the experiments, the printer 1 was left under LL environment (temperature of 10° C. and humidity of 20%) for 24 hours. Then, the printer 1 was turned on, and generation of noise was checked when the belt 21 (21A) moved during a start-up operation of the printer 1. As a result, the experimental data C1 and C2 shown in FIG. 11 were obtained.

From the experimental result shown in FIG. 11, it was found that the belt 21A of Embodiment 2 is superior to the belt 21 of Embodiment 1 in that generation of noise is suppressed. Therefore, it is understood that use of the binder layer 103 containing the solid lubricant is advantageous in enhancing quietness.

The reason is as follows. Noise is caused by a friction between the surface layer 110 of the belt 21 and the cleaning blade 27 (see FIG. 1). Particularly, noise is likely to occur under the LL environment in which a rubber resilience decreases.

In the belt 21A, the binder layer 103 contains solid lubricant. The solid lubricant is distributed to an entire body of the surface layer 110 of the belt 21A, and therefore static friction between the belt 21A and the cleaning blade 27 decreases. Therefore, the belt 21A can smoothly rotates, and noise associated with the start-up operation of the printer 1 can be suppressed.

Further, in the printer 1, it is not necessary to provide a supplying member of the solid lubricant so as not to contact the cleaning blade 27. Therefore, cost and freedom in layout of components of the printer 1 can be enhanced.

As described above, according to the belt 21A of Embodiment 2, the binder layer 103 contains the solid lubricant such as zinc stearate. Therefore, the belt 21A can smoothly move, and noise associated with start-up operation of the printer 1 can be suppressed.

As described in Embodiments 1 and 2, the printer 1 (i.e., the image forming apparatus) has a developer image bearing body (i.e., the belt 21, 21A) that bears a developer image formed of a developer (i.e., the toner 200). The developer image bearing body has roughness-imparting particles 104 on a surface thereof. A mean particle diameter d of the roughness-imparting particles and a mean particle diameter D of the developer satisfy a relationship: (½)×D<d<D.

If the mean particle diameter d of the roughness-imparting particles 104 is smaller than or equal to the lower limit (D/2) of the above described range, probability of contact between the developer image bearing body and external additives of the developer may increase. That is, the developer image bearing body and the external additives frequently contact each other. Therefore, the roughness-imparting particles may drop out from the developer image bearing body, or the external additives may drop out from the developer. When the image forming apparatus uses such developer image bearing body, factors causing deterioration of the image quality (for example, wear of the developer image bearing body, adhesion of the external additives to the developer image bearing body, insufficient cleaning of developer image bearing body and the like) may occur. As a result, the image forming apparatus may suffer from deterioration of image quality.

Further, if the mean particle diameter d of the roughness-imparting particles is larger than or equal to the upper limit (D) of the above described range, the particles of the developer may be buried in between the roughness-imparting particles. When the image forming apparatus uses such developer image bearing body, factors causing deterioration of the image quality (for example, insufficient transfer of the developer, insufficient cleaning of the developer image bearing body, damage to a cleaning member and the like) may occur. As a result, the image forming apparatus may suffer from deterioration of image quality.

In contrast, according to Embodiments 1 and 2 of the present invention, the mean particle diameter d of the roughness-imparting particles and the mean particle diameter D of the developer satisfy a relationship: (½)×D<d<D. Therefore, factors causing deterioration of image quality can be reduced, and high image quality can be achieved.

The present invention is not limited to a printer, but is applicable to an image forming apparatus such as a facsimile machine, copier, MFP or the like having an endless belt. In this regard, the “MFP” stands for Multi-Function Peripheral having functions of a printer, facsimile machine, scanner, copier and the like.

Further, the present invention is also applicable to an endless belt such as photosensitive belt, a fixing belt, conveying belt and the like.

In the above described Embodiments 1 and 2, the image forming apparatus 1 of the intermediate transfer type has been described. However, the present invention is not limited to the intermediate transfer type. For example, the present invention is applicable to an image forming apparatus in which a transfer unit transfers a developer image from a image bearing body (for example, a photosensitive drum) to a developer image bearing body (for example, a belt) or to a recording medium that moves along with the developer image bearing body.

While the preferred embodiments of the present invention have been illustrated in detail, it should be apparent that modifications and improvements may be made to the invention without departing from the spirit and scope of the invention as described in the following claims.

What is claimed is:

1. An image forming apparatus comprising:
a developer image bearing body that bears a developer image formed of a developer,
wherein said developer image bearing body has roughness-imparting particles on a surface thereof,
wherein a mean particle diameter d of said roughness-imparting particles and a mean particle diameter D of said developer satisfy a relationship:
(½)×D<d<D.

2. The image forming apparatus according to claim 1, wherein said developer image bearing body has a surface layer including said roughness-imparting particles and a binder layer.

3. The image forming apparatus according to claim 1, wherein said developer image bearing body includes a substrate provided below said surface layer.

4. The image forming apparatus according to claim 3, wherein said developer image bearing body includes a resilient layer provided between said surface layer and said substrate.

5. The image forming apparatus according to claim 2, wherein a thickness H of said binder layer and said mean particle diameter d of said roughness-imparting particles satisfy a relationship:
(½)>d<H<d.

6. The image forming apparatus according to claim 1, a pitch L at which said roughness-imparting particles are arranged satisfies a relationship:
L≦D+d.

7. The image forming apparatus according to claim 1, wherein said developer image bearing body is a belt.

8. The image forming apparatus according to claim 1, wherein said developer image bearing body is an endless belt.

9. The image forming apparatus according to claim 1, further comprising:
an image forming unit having an image bearing body and configured to form said developer image on said image bearing body;
a transfer unit having said developer image bearing body and configured to transfer said developer image from said image bearing body to said developer image bearing body or to a recording medium that moves along with said developer image bearing body, and
a fixing unit configured to fix said developer image to said recording medium.

10. The image forming apparatus according claim 9, further comprising a cleaning member configured to clean said developer image bearing body.

11. The image forming apparatus according claim 1, further comprising:
an image forming unit having an image bearing body and configured to form said developer image on said image bearing body;
a transfer unit having said developer image bearing body and configured to transfer said developer image from said image bearing body to said developer image bearing body and then transfer said developer image from said developer image bearing body to a recording medium, and
a fixing unit configured to fix said developer image to said recording medium.

12. The image forming apparatus according claim 11, further comprising a cleaning member configured to clean said developer image bearing body.
